(19) United States
(12) Patent Application Publication
(10) Pub. No.: US 2012/0125280 A1
(43) Pub. Date: May 24, 2012

(54) STARTING TORQUE TRANSMISSION MECHANISM FOR INTERNAL COMBUSTION ENGINE

(75) Inventor: Kazuaki Sugimura, Aichi-ken (JP)

(73) Assignee: TOYOTA JIDOSHA KABUSHIKI KAISHA, Toyota-shi (JP)

(21) Appl. No.: 13/384,493

(22) PCT Filed: Aug. 27, 2009
(86) PCT No.: PCT/JP2009/064974

§ 371 Date: Jan. 17, 2012

(51) Int. Cl. F02N 11/00

(52) U.S. Cl. 123/179.25

(57) ABSTRACT

A starting torque transmission mechanism for an internal combustion engine includes an inner race coupled to a crankshaft, a ring gear to which a rotational driving force from a starter motor is transmitted, and an outer race coupled to the ring gear. A one way clutch, a ball bearing, and an inner seal member are provided between an inner circumferential surface of the outer race and an outer circumferential surface of the inner race. The inner seal member is provided closer to the outer side of an internal combustion engine main body than the one way clutch and the ball bearing in the axial direction of the crankshaft, and blocks oil leakage from between the inner circumferential surface of the outer race and the outer circumferential surface of the inner race. The oil supply passage formed at the inner race connects the outside of the inner race with the inner seal member.

### TECHNICAL FIELD

The present invention relates to a starting torque transmission mechanism for an internal combustion engine for transmitting torque of a starter motor from a ring gear to a rotating output shaft of the internal combustion engine via a one way clutch.

### BACKGROUND ART

This type of conventional starting torque transmission mechanism for an internal combustion engine is described in, for example, Patent Document 1. In the conventional general starting torque transmission mechanism for an internal combustion engine including one described in Patent Document 1, the torque of the starter motor is transmitted from the ring gear to a crankshaft of the internal combustion engine via a one way clutch. A ball bearing for rotationally supporting the ring gear is provided between the ring gear and the crankshaft. A seal member for preventing oil supplied to the ball bearing and the one way clutch from leaking to the outside is provided on outer circumferences of the ball bearing and the one way clutch. By providing the ball bearing, the one way clutch and the sealing member in the radial direction of the crankshaft in this manner, the size of the internal combustion engine including the starting torque transmission mechanism in the axial direction can be reduced.

### Prior Art Document

Patent Document

Patent Document 1: Japanese Laid-Open Patent Publication No. 2007-247561

### SUMMARY OF THE INVENTION

### Problems that the Invention is to Solve

For example, when the conventional starting torque transmission mechanism described in Patent Document 1 is applied to an internal combustion engine having a large displacement, the following problem can occur. That is, generally, as the displacement of an internal combustion engine becomes larger, the diameter of the crankshaft also becomes larger. Thus, as the displacement of an internal combustion engine becomes larger, the distance between the center of the crankshaft and the seal member becomes longer. For this reason, as the displacement of the internal combustion engine becomes larger, the rotation radius of the seal member becomes larger. Accordingly, the circumferential speed of the seal member becomes larger. As a result, the frictional force in a sliding portion of the seal member becomes large, possibly causing problems such as thermal deterioration of the seal member and lowering of its sealing performance.

Thus, as shown in FIG. 11, a configuration in which a one way clutch 12, a ball bearing 14 and a seal member 16 are provided in this order from an internal combustion engine main body EB along the axial direction of the crankshaft 2 and between an inner circumferential surface of an outer race 6 and an outer circumferential surface of an inner race 804 has been developed. The crankshaft 2 is coupled to the inner race 804 and a ring gear 8 is coupled to the outer race 6 provided closer to the outer circumferential of the inner race 804. With such a configuration, the distance between the axial center of the crankshaft 2 and the seal member 16, in turn, the rotation radius of the inner seal member 16 can be reduced. Thereby, the circumferential speed of the inner seal member 16 can be reduced and accordingly, the frictional force in the sliding portion of the seal member 16 can be reduced, thereby suppressing lowering of the sealing performance by the seal member. With such a configuration, conventionally, as shown in this drawing, oil is supplied from an oil jet mechanism OJ to the one way clutch 12 and the ball bearing 14.

In such a starting torque transmission mechanism for an internal combustion engine, when lubricating oil is supplied from outside of the inner race and the outer race to the one way clutch and the ball bearing (rolling bearing), the following problem can occur. That is, since space defined by the inner circumferential surface of the outer race, the outer circumferential surface of the inner race and the seal member is shaped like a blind alley, the oil supplied from outside of the space accumulates in the seal member and is hard to be discharged. For this reason, the accumulated oil gradually deteriorates and becomes sludge, causing a problem in that the sealing performance of the seal member is reduced.

To suppress occurrence of such problems, the amount of oil supplied to the one way clutch and the rolling bearing may be reduced to suppress accumulation of oil in the seal member. However, in this case, the oil supplied to the sliding portion between the seal member and the inner race is likely to be insufficient. For this reason, a problem of reducing the sliding property of the seal member, and in turn, the sealing performance of the seal member can disadvantageously occur.

These problems are not limited to the configuration in which the one way clutch and the rolling bearing are provided in this order from the internal combustion engine main body and between the inner circumferential surface of the outer race and the outer circumferential surface of the inner race, but can commonly occur in, for example, a configuration in which the rolling bearing and the one way clutch are provided in this order from the internal combustion engine main body.

The present invention is made in consideration of such actual circumstances, and its objective is to provide a starting torque transmission mechanism for an internal combustion engine in which a one way clutch, a rolling bearing, and a seal member are provided along the axial direction of the rotating output shaft of the internal combustion engine and between the inner circumferential surface of the outer race and the outer circumferential surface of the inner race, and which can adequately supply or discharge oil to or from the seal member.

### Means for Solving the Problems

To achieve the above objective, a starting torque transmission mechanism for an internal combustion engine according to the present invention includes: an inner race coupled to a rotating output shaft of the internal combustion engine; a ring gear rotated by a starter motor in one direction; an outer race that is provided on an outer circumference of the inner race and is coupled to the ring gear; a one way clutch that is provided between an inner circumferential surface of the outer race and an outer circumferential surface of the inner race, allowing transmission of torque in the one direction from the ring gear to the inner race, while blocking transmission of the torque from the inner race to the ring gear; a rolling bearing provided between the inner circumferential surface of the outer race and the outer circumferential surface of the inner race; a seal member that is provided closer to the outer side of an internal combustion engine main body than the one way clutch and the rolling bearing in the axial direction of the rotating output shaft, the seal member blocking oil leakage from between the inner circumferential surface of the outer race and the outer circumferential surface of the inner race; and an oil supply passage that is formed at the inner race to connect the outside of the inner race with the seal member.

With this configuration, when oil is introduced from the outside of the inner race into an oil supply passage, in the passage, with rotation of the inner race, the centrifugal force acts on the oil and accordingly, the oil moves toward the seal member located closer to the outer circumference of the inner race and then, is supplied to the seal member. The oil supplied to the seal member is discharged to the outside through inner space of the one way clutch and the rolling bearing, which are located between the outer race and the inner race. Therefore, the oil can be adequately supplied to or discharged from the seal member.

It is preferable that an opening open to the outside of the inner race is formed between the inner circumferential surface of the inner race and the outer circumferential surface of the rotating output shaft over the entire inner race in the circumferential direction, and that the oil supply passage includes the opening.

With this configuration, since the opening formed between the inner circumferential surface of the inner race and the outer circumferential surface of the rotating output shaft constitutes a part of the oil supply passage, the oil can be reliably introduced from the outside of the inner race into the oil supply passage.

It is preferable that the oil supply passage includes an inner circumferential groove that is formed on an inner circumferential surface of the inner race and extends in the axial direction of the rotating output shaft.

With this configuration, since an inner circumferential groove formed on the inner circumferential surface of the inner race constitutes a part of the oil supply passage, a passage for introducing the oil from the outside of the inner race into the oil supply passage can be easily formed.

Especially, when the inner circumferential groove is formed in addition to the above-mentioned opening, oil existing in the opening moves in the circumferential direction of the inner race and is introduced into the inner circumferential groove as the inner race rotates. Thus, movement of the oil toward the seal member can be promoted, thereby supplying the oil to the seal member more adequately.

It is preferable that the oil supply passage includes an oil guiding portion, and that the oil guiding portion is formed such that the shorter the distance to the seal member from the outside of the inner race in the axial direction of the rotating output shaft, the more outward the oil guiding portion in the radial direction of the inner race is located.

With this configuration, when oil flows into the oil guiding portion, the oil is guided toward the radial outer side of the inner race through the oil guiding portion by the centrifugal force acting on the oil with rotation of the inner race. This promotes movement of the oil to the seal member and supplies the oil to the seal member more adequately.

Especially when the oil guiding portion is configured by the inner circumferential groove, for example, as compared to a configuration in which the entire oil guiding portion is formed in the inner race, the oil guiding portion can be formed more easily.

In this case, it is preferable that the oil guiding portion extends from the outside of the inner race toward the seal member in the axial direction of the rotating output shaft so as to be directed obliquely outward in the radial direction of the inner race.

With this configuration, when the centrifugal force acts on the oil in the oil guiding portion, a force acting toward the seal member is generated in the oil through the oil guiding portion. This promotes movement of the oil to the seal member and supplies the oil to the seal member more adequately.

The one way clutch can be embodied in a mode to be arranged closer to the internal combustion engine main body than the rolling bearing in the axial direction of the rotating output shaft.

In this case, it is preferable that the oil supply passage includes an outer circumferential groove that is formed at a part supporting the rolling bearing on the outer circumferential surface of the inner race and extends in the axial direction of the rotating output shaft.

With this configuration, since the outer circumferential groove formed on the outer circumferential surface of the inner race configures a part of the oil supply passage, the oil supply passage can be easily formed.

It is preferable that the oil supply passage is one of a plurality of oil supply passages provided in the circumferential direction of the inner race.

With this configuration, oil can be supplied from a plurality of places in the circumferential direction of the inner race to the seal member. Therefore, as compared to a configuration in which only one oil supply passage is provided, oil can be supplied to the seal member more adequately.

In this case, it is preferable that the plurality of oil supply passages have the same shape and are arranged at regular angular intervals in the circumferential direction of the inner race.

With this configuration, the oil can be uniformly supplied to a seal member in the circumferential direction of the inner race. Therefore, oil can be supplied to the seal member more adequately. Further, it is possible to prevent rotation fluctuation of the rotating output shaft due to formation of the oil supply passage on the inner race.

It is preferable that an oil jet mechanism for directly introducing oil into the oil supply passage is provided.

With this configuration, the oil can be adequately introduced into the oil supply passage and thus, the oil can be supplied to or discharged from the seal member more adequately.

### BRIEF DESCRIPTION OF THE DRAWINGS

FIG. 1 is a schematic cross-sectional view showing the configuration of a starting torque transmission mechanism for an internal combustion engine in accordance with a first embodiment of the present invention;

FIG. 2 is a partial cross-sectional view showing mainly an inner race in the starting torque transmission mechanism in FIG. 1;

FIG. 3 is a side view of the inner race when viewed from an A direction in FIG. 2;

FIG. 4 is a partial cross-sectional view showing mainly an inner race in a starting torque transmission mechanism for an internal combustion engine in accordance with a second embodiment of the present invention;

FIG. 5 is a partial cross-sectional view showing mainly an inner race in a starting torque transmission mechanism for an internal combustion engine in accordance with a third embodiment of the present invention;

FIG. 6 is a partial cross-sectional view showing mainly an inner race in a starting torque transmission mechanism for an internal combustion engine in accordance with a fourth embodiment of the present invention;

FIG. 7 is a partial cross-sectional view showing mainly an inner race of a starting torque transmission mechanism for an internal combustion engine according to a modified embodiment of the present invention;

FIG. 8 is a partial cross-sectional view showing mainly an inner race of a starting torque transmission mechanism for an internal combustion engine according to a modified embodiment of the present invention;

FIG. 9 is a partial cross-sectional view showing mainly an inner race of a starting torque transmission mechanism for an internal combustion engine according to still another modified embodiment;

FIG. 10 is a partial cross-sectional view showing mainly an inner race of a starting torque transmission mechanism for an internal combustion engine according to another modified embodiment of the present invention; and

FIG. 11 is a schematic cross-sectional view showing the configuration of a conventional starting torque transmission mechanism for an internal combustion engine.

### MODES FOR CARRYING OUT THE INVENTION

### First Embodiment

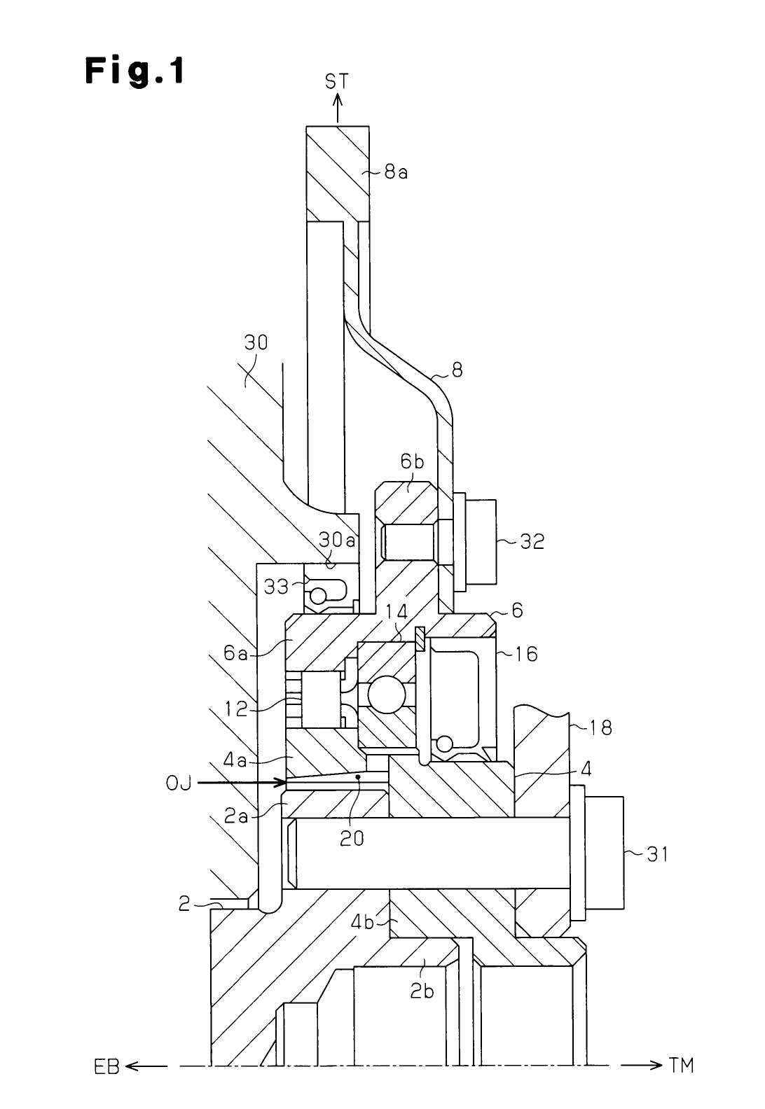

With reference to FIGS. 1 to 3, a starting torque transmission mechanism for an internal combustion engine according to a first embodiment of the present invention as an in-vehicle starting torque transmission mechanism for an internal combustion engine will be described.

FIG. 1 shows a cross-sectional structure of the starting torque transmission mechanism in this embodiment. This drawing is a cross-sectional view along the axial direction of the crankshaft 2 as a rotating output shaft of an internal combustion engine. In this drawing, the left side is closer to the internal combustion engine main body EB and the right side is closer to a transmission TM.

As shown in this drawing, the crankshaft 2 includes a large outer diameter portion 2a located at the outer side of a cylinder block 30, and a small outer diameter portion 2b that is located closer to the transmission TM than the large outer diameter portion 2a and has a smaller outer diameter than the large outer diameter portion 2a. A substantially cylindrical inner race 4 is provided on outer circumference of the large outer diameter portion 2a and the small outer diameter portion 2b. The inner race 4 includes a large inner diameter portion 4a having an inner circumferential surface opposed to the large outer diameter portion 2a of the crankshaft 2, and a small inner diameter portion 4b having an inner circumferential surface opposed to the small outer diameter portion 2b of the crankshaft 2. In the state where an end surface of the large outer diameter portion 2a of the crankshaft 2 closer to the transmission TM is in contact with an end surface of the small inner diameter portion 4b of the inner race 4 closer to the internal combustion engine main body EB, the crankshaft 2 is coupled to the inner race 4 via a bolt 31. Further, a fly wheel 18 is coupled to the crankshaft 2 and the inner race 4 via the bolt 31.

The substantially cylindrical outer race 6 is provided on the outer circumference of the inner race 4. The outer race 6 includes an outer race main body 6a and an annular protruding portion 6b protruding from the outer race main body 6a toward the radial outer side. The substantially disc-like ring gear 8 is provided on the outer circumference of the outer race 6. The protruding portion 6b of the outer race 6 is coupled to the ring gear 8 via a bolt 32. The rotational driving force from a starter motor ST is transmitted to a gear portion 8a of the ring gear 8. The ring gear 8 is rotated by the starter motor ST in one direction.

The one way clutch 12, the ball bearing 14 and the inner seal member 16 are provided in this order from the internal combustion engine main body EB and between the inner circumferential surface of the outer race 6 and the outer circumferential surface of the inner race 4.

A substantially arcuate seal attachment portion protruding toward the protruding portion 6b of the outer race 6 is formed on an end surface of the cylinder block 30 closer to the transmission TM. An outer seal member 33 is provided between an inner circumferential surface of the seal attachment portion 30a and an outer circumferential surface of the outer race main body 6a.

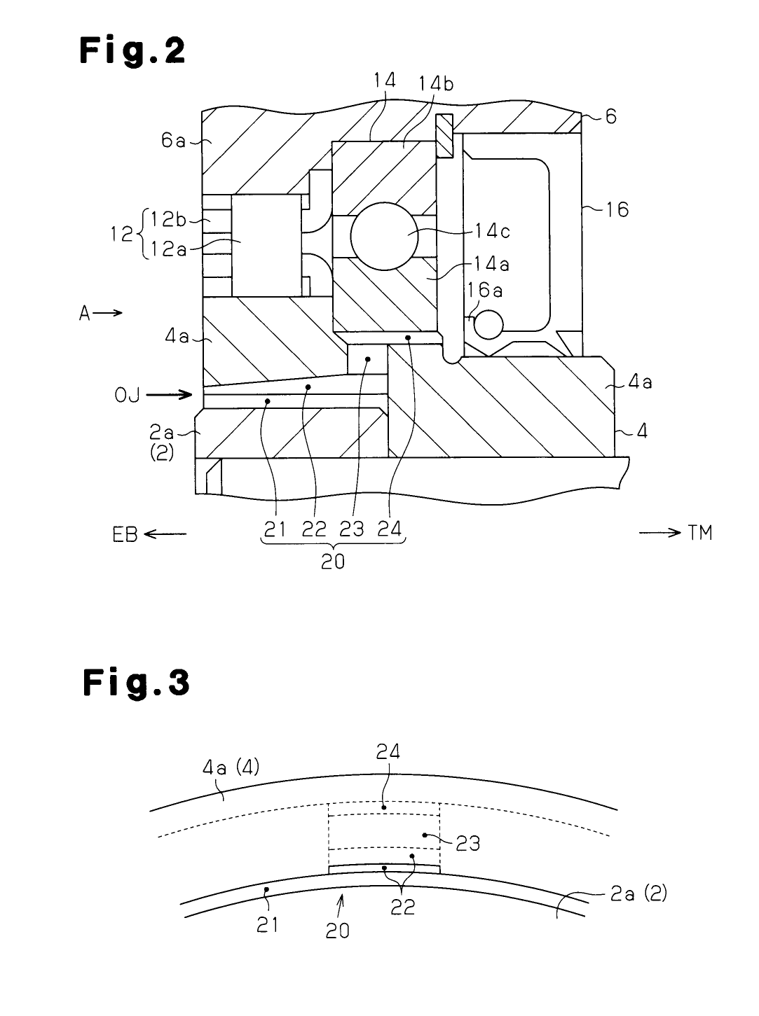

FIG. 2 shows the partial cross-sectional structure of mainly the inner race 4 in the starting torque transmission mechanism shown in FIG. 1.

As shown in this drawing, the one way clutch 12 includes a cage 12b having a sprag 12a, and the sprag 12a is sandwiched between the inner circumferential surface of the outer race 6 and the outer circumferential surface of the inner race 4. Thereby, the one way clutch 12 allows transmission of torque in one direction from the ring gear 8 to the inner race 4, and blocks transmission of torque in the reverse direction.

The ball bearing 14 includes a substantially annular inner race portion 14a fixed to the outer circumferential surface of the inner race 4, a substantially annular outer race portion 14b fixed to the inner circumferential surface of the outer race 6 and a ball 14c that can freely roll between the inner race portion 14a and the outer race portion 14b via a holder (not shown).

The inner seal member 16 is fixed to the outer race 6 at its outer circumference and a seal lip 16a formed on the inner circumference of the seal member 16 is in slidable contact with the outer circumferential surface of the inner race 4. In this manner, the inner seal member 16 seals a region between the inner circumferential surface of the outer race 6 and the outer circumferential surface of the inner race 4 at a position closer to the outer side of the internal combustion engine main body EB than the one way clutch 12 and the ball bearing 14 in the axial direction of the crankshaft 2, thereby blocking leakage of the oil from between the inner circumferential surface of the outer race 6 and the outer circumferential surface of the inner race 4. The ball bearing 14 corresponds to a rolling bearing according to the present invention and the inner seal member 16 corresponds to a seal member according to the present invention.

In such a starting torque transmission mechanism, when oil is supplied from the outside of the inner race 4 and the outer race 6 toward the one way clutch 12 and the ball bearing 14, the following problem can occur. That is, since space defined by the inner circumferential surface of the outer race 6, the outer circumferential surface of the inner race 4 and the inner seal member 16 is shaped like a blind alley, the oil supplied from the outside of the space accumulates in the inner seal member 16 and thus, is hard to be discharged. For this reason, the accumulated oil gradually deteriorates and becomes sludge, causing a problem in that the sealing performance by the inner seal member 16 is reduced.

Meanwhile, to suppress occurrence of such problems, the amount of oil supplied to the one way clutch 12 and the ball bearing 14 may be reduced, thereby suppressing accumulation of the oil in the inner seal member 16. However, in this case, the amount of oil supplied to the sliding portion with the inner seal member 16 and the inner race 4 is likely to be insufficient. For this reason, there is a problem with reducing the sliding property of the inner seal member 16, and in turn, sealing performance by the inner seal member 16 can disadvantageously occur.

Thus, in this embodiment, by forming an oil supply passage 20 connecting the outside of the inner race 4 with the inner seal member 16 on the inner race 4, oil can be adequately supplied to or discharged from the inner seal member 16.

Next, with reference to also FIG. 3, the specific configuration of the oil supply passage 20 will be described in detail. FIG. 3 is a side view showing the inner race 4 when viewed from an A direction in FIG. 2.

As shown in FIGS. 2 and 3, the oil supply passage 20 is configured including an opening 21, an inner circumferential groove 22, an outer circumferential groove 24 and a communicating hole 23.

The opening 21 is formed between the inner circumferential surface of the inner race 4 and the outer circumferential surface of the crankshaft 2. Specifically, as shown in FIG. 3, the inner diameter of the large inner diameter portion 4a of the inner race 4 is larger than the outer diameter of the large outer diameter portion 2a of the crankshaft 2, resulting in that the opening 21 open to the outside of the inner race 4 closer to the internal combustion engine main body EB is formed between the inner circumferential surface of the large inner diameter portion 4a of the inner race 4 and the outer circumferential surface of the large outer diameter portion 2a of the crankshaft 2 over the entire circumference of the inner race 4.

The inner circumferential groove 22 is formed on the inner circumferential surface of the large inner diameter portion 4a of the inner race 4 so as to extend in the axial direction of the crankshaft 2. The inner circumferential groove 22 is formed such that the shorter the distance to the inner seal member 16 from the side closer to the internal combustion engine main body EB in the axial direction of the crankshaft 2, the more outward in the radial direction of the inner race 4 the bottom surface of the groove 22, that is, the outer surface of the oil supply passage 20 in the radial direction is located. More specifically, the bottom surface of the inner circumferential groove 22 extends from the side closer to the internal combustion engine main body EB toward the inner seal member 16 in the axial direction of the crankshaft 2 so as to be directed obliquely outward in the radial direction of the inner race 4, that is, to continuously deepen. The four inner circumferential grooves 22 are provided in the circumferential direction of the inner race 4. These four inner circumferential grooves 22 have the same shape and are arranged at regular angular intervals (90 degrees in this embodiment) in the circumferential direction of the inner race 4. In addition, the inner circumferential groove 22 corresponds to an inner circumferential groove and an oil guiding portion according to the present invention.

The outer circumferential groove 24 is formed so as to extend in the axial direction of the crankshaft 2 at a part that supports the inner race portion 14a of the ball bearing 14 on the outer circumferential surface of the inner race 4.

The communicating hole 23 is a hole connecting an end of the inner circumferential groove 22 closer to the inner seal member 16 and an end of the outer circumferential groove 24 closer to the internal combustion engine main body EB, and extends in the radial direction of the inner race 4. That is, the communicating hole 23 is formed along the end surface of the small inner diameter portion 4b of the inner race 4 closer to the internal combustion engine main body EB.

As shown in FIGS. 1 and 2, the cylinder block 30 is provided with an oil jet mechanism OJ for directly jetting the oil of the internal combustion engine to the opening 21 and the inner circumferential groove 22 of the oil supply passage 20.

In the starting torque transmission mechanism for an internal combustion engine including such an oil supply passage 20, when oil is introduced into the opening 21 or the inner circumferential groove 22 of the oil supply passage 20 through the oil jet mechanism OJ, in the passage 20, centrifugal force acts on the oil with rotation of the inner race 4. As a result, the oil moves toward the inner seal member 16 located on the side of the outer circumference of the inner race 4 and then, is supplied to the inner seal member 16. The oil supplied to the inner seal member 16 is discharged to the outside through the inner space in the one way clutch 12 and the ball bearing 14.

The starting torque transmission mechanism for an internal combustion engine in accordance with this embodiment described above can obtain the following advantages.

(1) The starting torque transmission mechanism for an internal combustion engine includes the inner race 4 coupled to the crankshaft 2, the ring gear 8 to which the rotational driving force from the starter motor ST is transmitted and the outer race 6 that is provided on the outer circumference of the inner race 4 and is coupled to the ring gear 8. The one way clutch 12, the ball bearing 14 and the inner seal member 16 are provided between the inner circumferential surface of the outer race 6 and the outer circumferential surface of the inner race 4. The inner seal member 16 is provided closer to the outer side of the internal combustion engine main body EB than the one way clutch 12 and the ball bearing 14 in the axial direction of the crankshaft 2, and blocks oil leakage from between the inner circumferential surface of the outer race 6 and the outer circumferential surface of the inner race 4. The oil supply passage 20 formed at the inner race 4 connects the outside of the inner race 4 with the inner seal member 16. With such a configuration, when the oil is introduced from the outside of the inner race 4 into the oil supply passage 20, in the passage 20, the centrifugal force acts on the oil with rotation of the inner race 4 and therefore, the oil moves toward the inner seal member 16 located closer to the outer circumference of the inner race 4 and then, is supplied to the inner seal member 16. The oil supplied to the inner seal member 16 is discharged to the outside through inner space in the one way clutch 12 and the ball bearing 14, which are located between the inner circumferential surface of the outer race 6 and the outer circumferential surface of the inner race 4. Accordingly, the oil can be adequately supplied to or discharged from the inner seal member 16.

(2) The opening 21 open to the outside of the inner race 4 is formed between the inner circumferential surface of the inner race 4 and the outer circumferential surface of the crankshaft 2 over the entire circumference of the inner race 4, and the oil supply passage 20 includes the opening 21. With such a configuration, since the opening 21 formed between the inner circumferential surface of the inner race 4 and the outer circumferential surface of the crankshaft 2 constitutes a part of the oil supply passage 20, the oil can be reliably introduced from the outside of the inner race 4 into the oil supply passage 20.

(3) The oil supply passage 20 includes the inner circumferential groove 22 formed on the inner circumferential surface of the inner race 4 so as to extend in the axial direction of the crankshaft 2. With such a configuration, since the inner circumferential groove 22 formed on the inner circumferential surface of the inner race 4 constitutes a part of the oil supply passage 20, the passage for introducing the oil from the outside of the inner race 4 into the oil supply passage 20 can be easily formed. Moreover, since the inner circumferential groove 22 in addition to the opening 21 is formed, the oil existing in the opening 21 moves in the circumferential direction of the inner race 4 with rotation of the inner race 4 and then, is introduced into the inner circumferential groove 22. This can promote movement of the oil toward the inner seal member 16 and supply the oil to the seal member 16 more adequately.

(4) The inner circumferential groove 22 (specifically, its bottom surface) is formed such that the shorter the distance to the inner seal member 16 from the side closer to the internal combustion engine main body EB in the axial direction of the crankshaft 2, the more outward in the radial direction of the inner race the inner circumferential groove 22 is located. With such a configuration, when the oil flows into the inner circumferential groove 22, by the centrifugal force acting on the oil with rotation of the inner race 4, the oil is guided to the outer side in the radial direction of the inner race 4 through the bottom surface of the inner circumferential groove 22. That can promote movement of the oil to the inner seal member 16 and supply the oil to the inner seal member 16 more adequately. Moreover, since the inner circumferential groove 22 configures the oil guiding portion, for example, as compared to the case where the entire oil guiding portion is formed in the inner race 4, the oil guiding portion can be formed more easily.

(5) The inner circumferential groove 22 (specifically, its bottom surface) extends from the side closer to the internal combustion engine main body EB toward the inner seal member 16 in the axial direction of the crankshaft 2 so as to be directed obliquely outward in the radial direction of the inner race 4. With such a configuration, when the centrifugal force acts on the oil in the inner circumferential groove 22, a force toward the inner seal member 16 is generated in the oil through the bottom surface of the inner circumferential groove 22. This can further promote movement of the oil toward the inner seal member 16 and supply the oil to the inner seal member 16 more adequately.

(6) The one way clutch 12 is arranged closer to the internal combustion engine main body EB than the ball bearing 14 in the axial direction of the crankshaft 2. The oil supply passage 20 includes the outer circumferential groove 24 formed at the part supporting the inner race portion 14a of the ball bearing 14 on the outer circumferential surface of the inner race 4 so as to extend in the axial direction of the crankshaft 2. With such a configuration, since the outer circumferential groove 24 formed on the outer circumferential surface of the inner race 4 constitutes a part of the oil supply passage 20, the oil supply passage 20 can be easily formed.

(7) The four oil supply passages 20 are provided in the circumferential direction of the inner race. With such a configuration, the oil can be supplied from four places in the circumferential direction of the inner race 4 to the inner seal member 16. Therefore, for example, as compared to a case where only one oil supply passage 20 is provided, the oil can be supplied to the inner seal member 16 more adequately.

(8) The four oil supply passages 20 have the same shape and are arranged at regular angular intervals (90 degrees) in the circumferential direction of the inner race 4. With such a configuration, the oil can be uniformly supplied to the inner seal member 16 in the circumferential direction of the inner race 4. Accordingly, the oil can be supplied to the inner seal member 16 more adequately. Moreover, it is possible to prevent rotation fluctuation of the crankshaft 2 due to formation of the oil supply passage 20 at the inner race 4.

(9) The oil jet mechanism OJ for directly introducing the oil into the oil supply passage 20 is provided. With such a configuration, the oil can be adequately introduced into the oil supply passage 20, and the oil can be supplied to or discharged from the inner seal member 16 more adequately.

### Second Embodiment

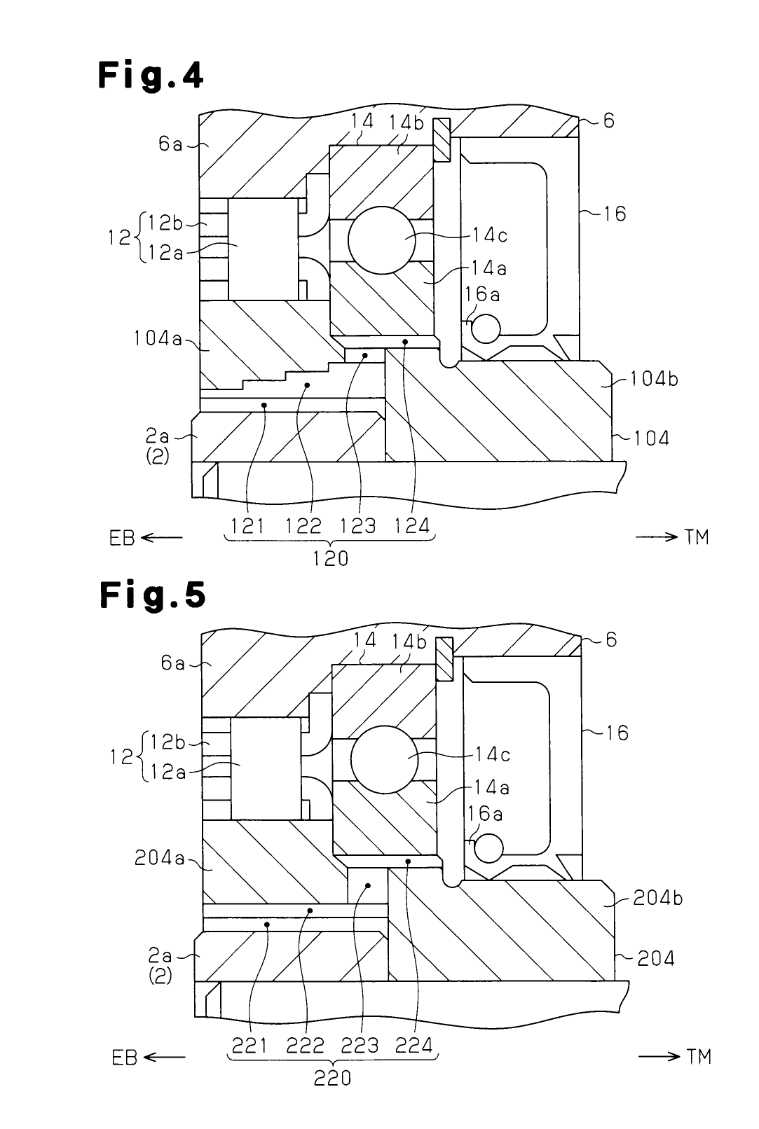

A starting torque transmission mechanism for an internal combustion engine according to a second embodiment of the present invention will be described below with reference to FIG. 4.

FIG. 4 shows a partial cross-sectional configuration of mainly an inner race 104 of the starting torque transmission mechanism in accordance with this embodiment. The same components in this drawing as those in the first embodiment are given the same reference numerals and overlapping description thereof is omitted. The components in this drawing, which correspond to those in the first embodiment, are given corresponding reference numerals. Specifically, the components having reference numerals “xx” in the first embodiment are given reference numerals “1xx”.

This embodiment is different from the first embodiment in the configuration of an inner circumferential groove 122 of an oil supply passage 120. The difference between this embodiment and the first embodiment will be mainly described.

As shown in FIG. 4, also in this embodiment, the inner circumferential groove 122 is formed on an inner circumferential surface of a large inner diameter portion 104a of the inner race 104 so as to extend in the axial direction of the crankshaft 2. However, the inner circumferential groove 122 is formed in a stepped manner such that the shorter the distance to the inner seal member 16 from the side closer to the internal combustion engine main body EB in the axial direction of the crankshaft 2, the more outward in the radial direction of the inner race 104 the bottom surface of the inner circumferential groove 122, that is, the outer side surface of the oil supply passage 120 in the radial direction is located.

The starting torque transmission mechanism for an internal combustion engine in accordance with this embodiment described above can obtain similar advantages to the advantages (1) to (4) and (6) to (9) in the first embodiment.

### Third Embodiment

A starting torque transmission mechanism for an internal combustion engine according to a third embodiment of the present invention will be described below with reference to FIG. 5.

FIG. 5 shows a partial cross-sectional structure of mainly an inner race 204 in the starting torque transmission mechanism in accordance with this embodiment. The same components in this drawing as those in the first embodiment are given the same reference numerals and overlapping description thereof is omitted. The components in this drawing, which correspond to those in the first embodiment, are given corresponding reference numerals. Specifically, the components having reference numerals “xx” in the first embodiment are given reference numerals “2xx”.

This embodiment is different from the first embodiment and the second embodiment in the configuration of an inner circumferential groove 222 of an oil supply passage 220. The difference between this embodiment and the first and second embodiments will be described below.

As shown in FIG. 5, also in this embodiment, the inner circumferential groove 222 is formed on an inner circumferential surface of a large inner diameter portion 204a of the inner race 204 so as to extend in the axial direction of the crankshaft 2. However, the distance between the outer circumferential surface of the large outer diameter portion 2a of the crankshaft 2 and the bottom surface of the inner circumferential groove 22, that is, a radial outer side surface of the oil supply passage 220, is made constant in the axial direction of the crankshaft 2.

The starting torque transmission mechanism for an internal combustion engine in accordance with this embodiment described above can obtain similar advantages to the advantages (1) to (3) and (6) to (9) in the first embodiment.

### Fourth Embodiment

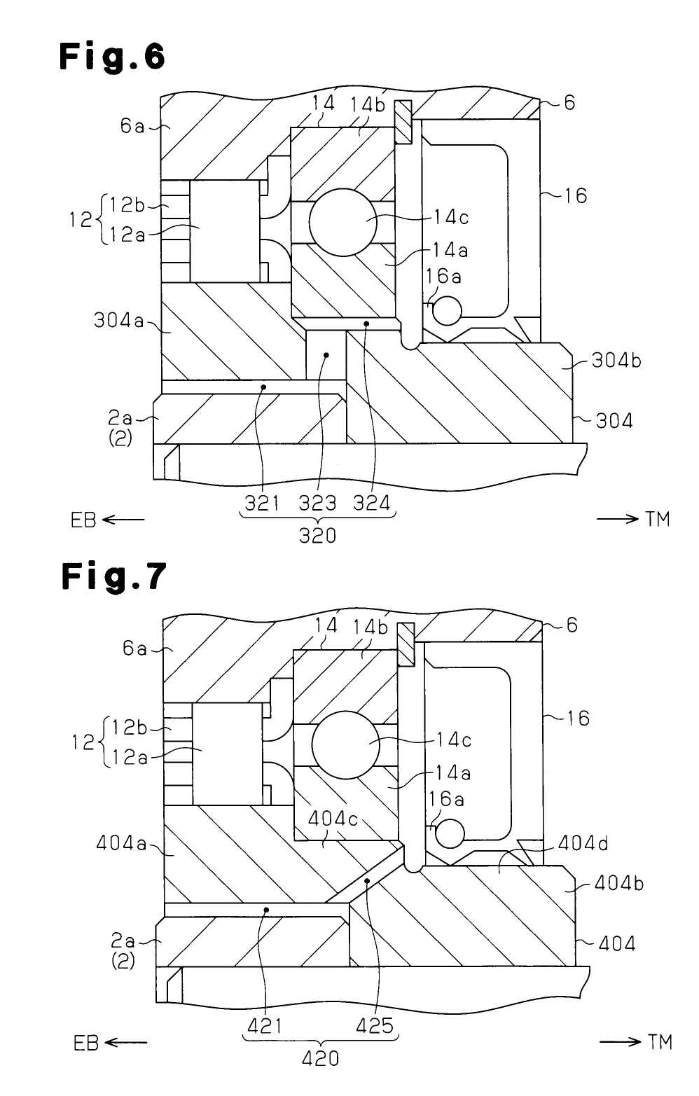

With reference to FIG. 6, a starting torque transmission mechanism for an internal combustion engine according to a fourth embodiment of the present invention will be described below.

FIG. 6 shows a partial cross-sectional structure of mainly an inner race 304 in the starting torque transmission mechanism in accordance with this embodiment. The same components in this drawing as those in the first embodiment are given the same reference numerals and overlapping description thereof is omitted. The components in this drawing, which correspond to those in the first embodiment, are given corresponding reference numerals. Specifically, the components having reference numerals “xx” in the first embodiment are given reference numerals “3xx”.

This embodiment is different from the first embodiment to the third embodiment in that an oil supply passage 320 has no inner circumferential grooves 22, 122, 222 described in the first embodiment to the third embodiment, respectively. The difference between this embodiment and the first embodiment with respect to the third embodiment will be mainly described below.

As shown in FIG. 6, also in this embodiment, the inner diameter of a large inner diameter portion 304a of the inner race 304 is larger than the outer diameter of the large outer diameter portion 2a of the crankshaft 2. As a result, an opening 321 open to the outside of the inner race 304 closer to the internal combustion engine main body EB is formed between the inner circumferential surface of the large inner diameter portion 304a of the inner race 304 and the outer circumferential surface of the large outer diameter portion 2a of the crankshaft 2 over the entire circumference of the inner race 304.

An outer circumferential groove 324 is formed at a part supporting the inner race portion 14a of the ball bearing 14 on the outer circumferential surface of the inner race 304 so as to extend in the axial direction of the crankshaft 2.

A communicating hole 323 is a hole connecting an end of the outer circumferential groove 324 closer to the internal combustion engine main body EB with the opening 321, and extends in the radial direction of the inner race 304.

The starting torque transmission mechanism for an internal combustion engine in accordance with this embodiment described above can obtain advantages similar to the advantages (1), (2) and (6) to (9) of the first embodiment.

The starting torque transmission mechanism for an internal combustion engine according to the present invention is not limited to the configuration described in the above-mentioned embodiments, and can be implemented as, for example, following appropriately modified embodiments.

Although the four oil supply passages 20, 120, 220, 320 are arranged at regular intervals of 90 degrees in the circumferential direction of the inner races 4, 104, 204, 304, respectively, in each of the above-mentioned embodiments, for example, eight oil supply passages may be arranged at intervals of 45 degrees in the circumferential direction of the inner race.

An oil supply passage 420 shown in FIG. 7 may be adopted in place of the oil supply passage 320 illustrated in the fourth embodiment. That is, as shown in this drawing, the inner race 404 is formed in a stepped manner such that its outer diameter becomes smaller toward the transmission TM in the axial direction of the crankshaft 2. Specifically, the outer diameter of a supporting portion 404c supporting the inner race portion 14a of the ball bearing 14 is larger than that of a sliding portion 404d on which the seal lip 16a of the inner seal member 16 slides. The oil supply passage 420 is configured to include an opening 421 and an oil guiding portion 425. The oil guiding portion 425 is formed so as to connect an end of the opening 421 closer to the transmission TM with an end of the supporting portion 404c of the inner race 404 closer to the transmission TM. An outer circumferential surface of the oil guiding portion 425 extends from the side closer to the internal combustion engine main body EB toward the inner seal member 16 in the axial direction of the crankshaft 2 so as to be directed obliquely outward in the radial direction of the inner race 4. With such a configuration, when the oil flows into the oil guiding portion 425, by the centrifugal force acting on the oil with rotation of the inner race 404, the oil is guided toward the radial outer side of the inner race 404 through the oil guiding portion 425. This can promote movement of the oil to the inner seal member 16 and adequately supply the oil to the inner seal member 16.

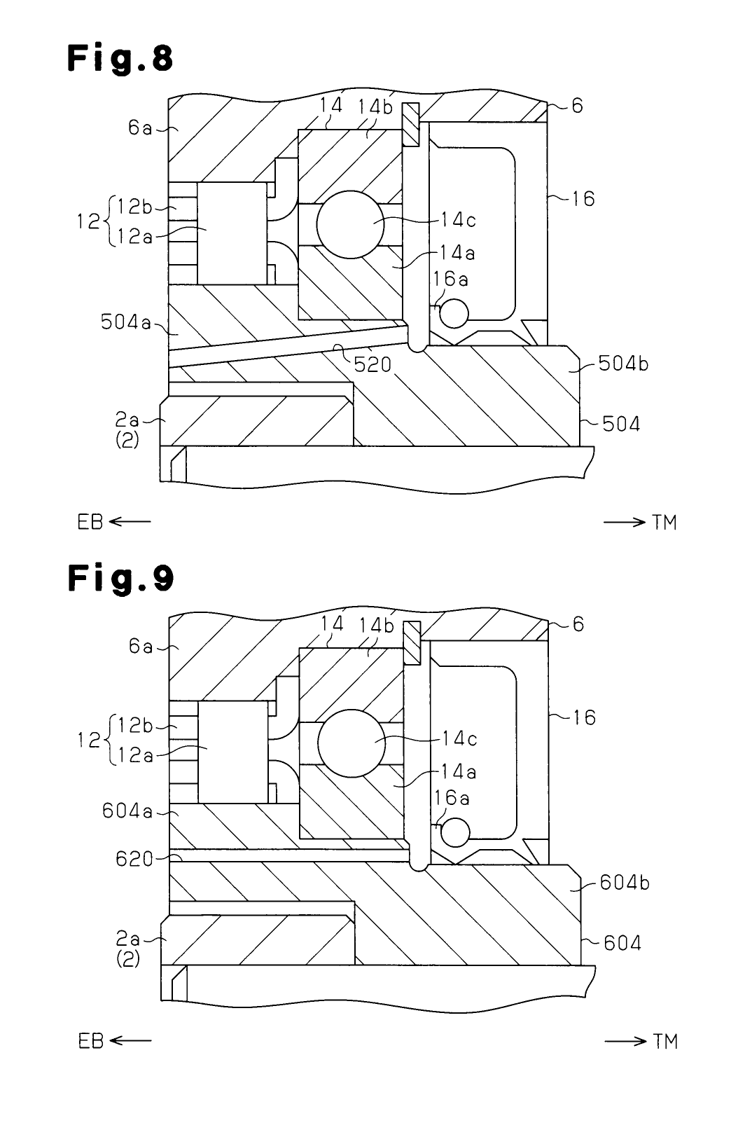

Although the openings 21, 121, 221, 321, 421 formed between the inner circumferential surfaces of the inner races 4, 104, 204, 304, 404 and the outer circumferential surface of the crankshaft 2, respectively, constitute a part of the oil supply passages 20, 120, 220, 320, 420 in each of the above-mentioned embodiments, the oil supply passage according to the present invention is not limited to these. For example, as shown in FIGS. 8 and 9, the whole of oil supply passages 520, 620 may be formed in the inner races 504, 604, respectively. Additionally, as shown in FIG. 8, the oil supply passage 520 is formed so as to connect an end of a large inner diameter portion 504a of the inner race 504 closer to the internal combustion engine main body EB with and end of a supporting portion 504c of an inner race 504 closer to the transmission TM. The oil supply passage 520 extends from the side closer to the internal combustion engine main body EB toward the inner seal member 16 in the axial direction of the crankshaft 2 so as to be directed obliquely outward in the radial direction of the inner race 4. Further, as shown in FIG. 9, the oil supply passage 620 connects an end of a large inner diameter portion 604a of an inner race 604 closer to the internal combustion engine main body EB with an end of a supporting portion 604c of the inner race 604 closer to the transmission TM, and extends in parallel to the axial direction of the crankshaft 2.

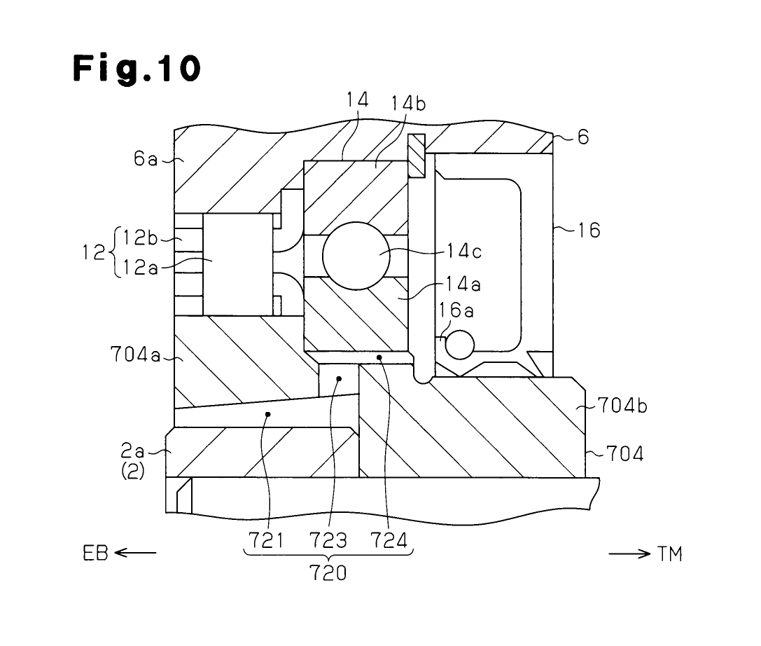

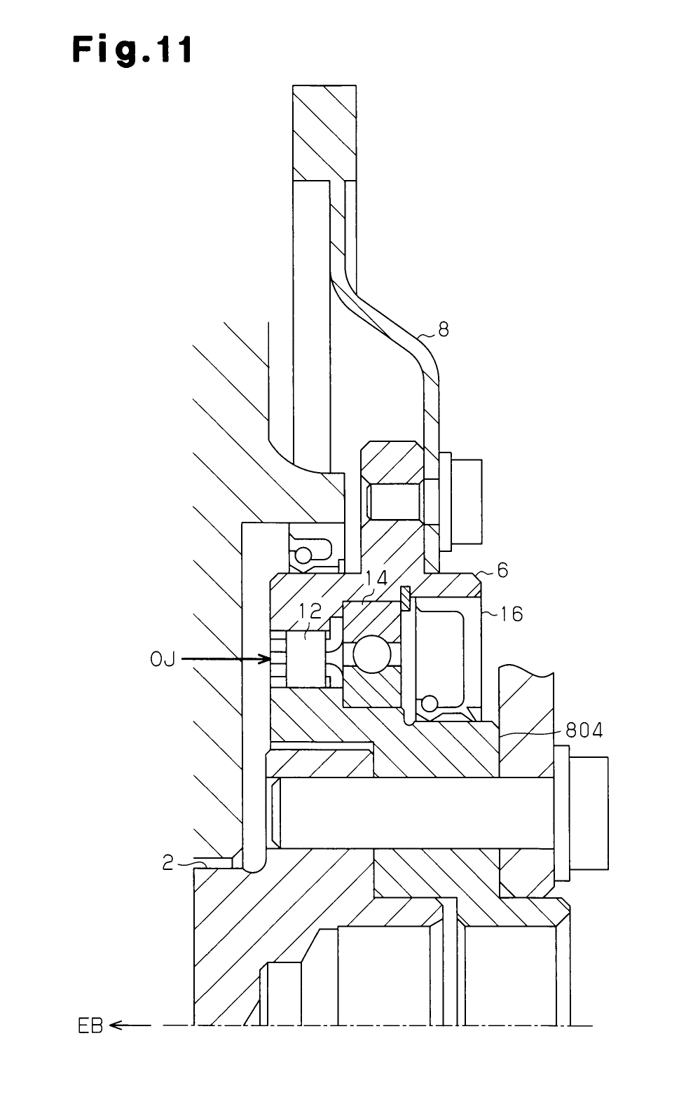

Although as shown in FIGS. 1 to 3, the oil supply passage 20 configured to include the opening 21, the inner circumferential groove 22, the outer circumferential groove 24 and the communicating hole 23 is illustrated in the first embodiment, an oil supply passage 720 shown in FIG. 10 may be adopted in place of the oil supply passage 20. That is, as shown in this drawing, as the inner diameter of a large inner diameter portion 704a of an inner race 704 is formed to become smaller from the side closer to the internal combustion engine main body EB toward the transmission TM in the axial direction of the crankshaft 2. As a result, an opening 721 open to the outside of the inner race 704 closer to the internal combustion engine main body EB is formed between an inner circumferential surface of the inner race 704 and the outer circumferential surface of the large outer diameter portion 2a of the crankshaft 2 over the entire circumference of the inner race 704. In such an oil supply passage 720, when the centrifugal force acts on the oil in the opening 721, a force toward the inner seal member 16 is generated in the oil through the inner circumferential surface of the large inner diameter portion 704a of the inner race 704. This can promote movement of the oil to the inner seal member 16 and adequately supply the oil to the inner seal member 16. Furthermore, with such a configuration, a configuration corresponding to the inner circumferential groove 22 illustrated in the first embodiment can be omitted. In addition, a configuration of a communicating hole 723 and an outer circumferential groove 724 is the same as the communicating hole 23 and the outer circumferential groove 24 in the first embodiment, respectively.

In each of the above-mentioned embodiments, configurations are illustrated in which the one way clutch 12 and the ball bearing 14 are provided in this order from the side closer to the internal combustion engine main body EB and between the inner circumferential surface of the outer race 6 and the outer circumferential surface of each of the inner races 4, 104, 204, 304, 404, 504, 604, 704. However, the arrangement of the one way clutch 12 and the ball bearing 14 is not limited to this, and the ball bearing and the one way clutch may be provided in this order from the side closer to the internal combustion engine main body EB.

Although the ball bearing 14 is used as an example of a rolling bearing in the above-mentioned embodiments, a rolling bearing according to the present invention is not limited to the ball bearing, and a roller bearing may be adopted as the rolling bearing.

1. A starting torque transmission mechanism for an internal combustion engine, the mechanism comprising:
an inner race coupled to a rotating output shaft of the internal combustion engine;
a ring gear rotated by a starter motor in one direction;
an outer race that is provided on an outer circumference of the inner race and is coupled to the ring gear;
a one way clutch that is provided between an inner circumferential surface of the outer race and an outer circumferential surface of the inner race, allowing transmission of torque in the one direction from the ring gear to the inner race, while blocking transmission of the torque from the inner race to the ring gear;
a rolling bearing provided between the inner circumferential surface of the outer race and the outer circumferential surface of the inner race;
a seal member that is provided closer to the outer side of an internal combustion engine main body than the one way clutch and the rolling bearing in the axial direction of the rotating output shaft, the seal member blocking oil leakage from between the inner circumferential surface of the outer race and the outer circumferential surface of the inner race; and
an oil supply passage that is formed at the inner race and extends through the inner race to connect the outside of the inner race with the seal member.

2. The starting torque transmission mechanism for an internal combustion engine according to claim 1, wherein
an opening open to the outside of the inner race is formed between the inner circumferential surface of the inner race and the outer circumferential surface of the rotating output shaft over the entire inner race in the circumferential direction, and
the oil supply passage includes the opening.

3. The starting torque transmission mechanism for an internal combustion engine according to claim 1, wherein
the oil supply passage includes an inner circumferential groove that is formed on an inner circumferential surface of the inner race and extends in the axial direction of the rotating output shaft.

4. The starting torque transmission mechanism for an internal combustion engine according to claim 1, wherein
the oil supply passage includes an oil guiding portion, and the oil guiding portion is formed such that the shorter the distance to the seal member from the outside of the inner race in the axial direction of the rotating output shaft, the more outward the oil guiding portion in the radial direction of the inner race is located.

5. The starting torque transmission mechanism for an internal combustion engine according to claim 4, wherein
the oil guiding portion extends from the outside of the inner race toward the seal member in the axial direction of the rotating output shaft so as to be directed obliquely outward in the radial direction of the inner race.

6. The starting torque transmission mechanism for an internal combustion engine according to claim 1, wherein
the one way clutch is arranged closer to the internal combustion engine main body than the rolling bearing in the axial direction of the rotating output shaft.

7. The starting torque transmission mechanism for an internal combustion engine according to claim 6, wherein
the oil supply passage includes an outer circumferential groove that is formed at a part supporting the rolling bearing on the outer circumferential surface of the inner race and extends in the axial direction of the rotating output shaft.

8. The starting torque transmission mechanism for an internal combustion engine according to claim 1, wherein
the oil supply passage is one of a plurality of oil supply passages provided in the circumferential direction of the inner race.

9. The starting torque transmission mechanism for an internal combustion engine according to claim 8, wherein
the plurality of oil supply passages have the same shape and are arranged at regular angular intervals in the circumferential direction of the inner race.

10. The starting torque transmission mechanism for an internal combustion engine according to claim 1, further comprising an oil jet mechanism for directly introducing oil into the oil supply passage.
